(19) United States
(12) Patent Application Publication
(10) Pub. No.: US 2024/0122246 A1
(43) Pub. Date: Apr. 18, 2024

(54) ATOMIZING CORE OF ELECTRONIC CIGARETTE AND ELECTRONIC CIGARETTE

(71) Applicant: BYD PRECISION MANUFACTURE CO., LTD., Shenzhen (CN)

(72) Inventors: Hu ZHOU, Shenzhen (CN); Guirong YUE, Shenzhen (CN); Chaonan CHEN, Shenzhen (CN)

(21) Appl. No.: 18/399,729

(22) Filed: Dec. 29, 2023

Related U.S. Application Data
(63) Continuation of application No. PCT/CN2021/129902, filed on Nov. 10, 2021.

(30) Foreign Application Priority Data
Aug. 19, 2021 (CN) 202110957241.5

(51) Int. Cl. A24F 40/46; A24F 40/10; A24F 40/42; A24F 40/44; A24F 40/485; H05B 3/06

(52) U.S. Cl. CPC A24F 40/46; A24F 40/10; A24F 40/42; A24F 40/44; A24F 40/485; H05B 3/06; H05B 2203/003; H05B 2203/004; H05B 2203/016

(57) ABSTRACT

An electronic cigarette vaporization core and an electronic cigarette, the electronic cigarette vaporization core includes a porous body and a heating body. The porous body includes a liquid absorbing end and a vaporization end, a bump is arranged on the vaporization end, and the bump includes an end surface facing away from the porous body and a side surface located on an outer periphery of the bump. The heating body is arranged on the end surface, and a distance between at least a part of the heating body and an edge of the end surface is less than a predetermined value, so that both at least a part of the end surface and at least a part of the side surface form vaporization surfaces. Therefore, when the vaporization surface formed on the bump is fully used, utilization efficiency of heat energy of the heating body can be ensured on the basis of improving a heating speed of the heating body.

### CROSS-REFERENCE TO RELATED APPLICATIONS

This application is a continuation of International Application No. PCT/CN2021/129902, filed on Nov. 10, 2021, which claims priority to Chinese Patent Application No. 202110957241.5, filed on Aug. 19, 2021 and entitled “ELECTRONIC CIGARETTE VAPORIZATION CORE AND ELECTRONIC CIGARETTE”, which is incorporated herein by reference in its entirety.

### FIELD

The present disclosure relates to the field of electronic cigarette vaporization assembly technologies, and specifically, the present disclosure relates to an electronic cigarette vaporization core and an electronic cigarette.

### BACKGROUND

A vaporization core is an important component in an electronic vaporization apparatus and mainly includes a porous body and a heating body arranged on a surface of the porous body. The porous body is in communication with an e-liquid storage cavity that stores to-be-vaporized liquid, and may conduct the to-be-vaporized liquid to the heating body, and the to-be-vaporized liquid is vaporized after being heated by the heating body.

However, currently, a heating body of a ceramic vaporization core on the market is obtained by directly printing electronic paste on a porous body, and then performing baking at high temperature, electrode connection, and lead wire processing. A total area of a vaporization end of an existing porous body is relatively large, but due to the impact of a shape of a heating body and heat transfer of a carrier, a proportion of an effective heating area of the vaporization core in the total area is relatively small. In addition, due to a relatively large volume of the porous body, heat loss of the heating body is relatively large, and utilization of heat energy of the heating body in an electronic cigarette is reduced.

### SUMMARY

An objective of embodiments of the present disclosure is to provide a new technical solution of an electronic cigarette vaporization core and an electronic cigarette.

According to a first aspect of the present disclosure, an electronic cigarette vaporization core is provided. The electronic cigarette vaporization core includes a porous body and a heating body.

The porous body includes a liquid absorbing end and a vaporization end. A bump is arranged on the vaporization end, and the bump includes an end surface facing away from the porous body and a side surface located on an outer periphery of the bump.

The heating body is arranged on the end surface, and a distance between at least a part of the heating body and an edge of the end surface is less than a predetermined value. so that both at least a part of the end surface and at least a part of the side surface form vaporization surfaces.

According to an embodiment of the present disclosure, the heating body is bent in a circumferential direction of the bump to form at least one raised section, or the heating body is bent in a circumferential direction of the bump to form at least one recessed section, or the heating body is bent in a circumferential direction of the bump to form at least one raised section and at least one recessed section.

According to the embodiment of the present disclosure, a contour of the edge of the end surface forms a raised edge adapted to the raised section at a position corresponding to the raised section.

According to the embodiment of the present disclosure, the contour of the edge of the end surface forms a recessed edge adapted to the recessed section at a position corresponding to the recessed section.

According to the embodiment of the present disclosure, the heating body is arranged on the end surface in a shape of square wave.

According to the embodiment of the present disclosure, the heating body is arranged on the end surface in an S shape.

According to the embodiment of the present disclosure, the heating body is arranged on the end surface in a wave shape.

According to the embodiment of the present disclosure, the heating body is arranged on the end surface in an arc shape.

According to the embodiment of the present disclosure, a distance between an overall contour of the heating body and the edge of the end surface ranges from 0.05 mm to 4.0 mm.

According to the embodiment of the present disclosure, a distance between the raised section and the edge of the end surface ranges from 0.1 mm to 2.0 mm.

According to the embodiment of the present disclosure, a distance between the recessed section and the edge of the end surface ranges from 0.1 mm to 4.0 mm.

According to the embodiment of the present disclosure, the electronic cigarette vaporization core further includes a wiring pad, the wiring pad being connected to two ends of the heating body.

According to the embodiment of the present disclosure, a ratio of an area of the wiring pad to an area of the end surface is 0.02 to 0.25.

According to the embodiment of the present disclosure, a height of the bump ranges from 0.1 mm to 5 mm.

According to the embodiment of the present disclosure, the bump and the porous body are integrally formed.

According to an embodiment of the present disclosure, an electronic cigarette is provided, including the electronic cigarette vaporization core according to the first aspect.

According to an embodiment of the present disclosure, the electronic cigarette includes the electronic cigarette vaporization core of the present disclosure, a housing, a liquid storage cavity provided in the housing, a vaporization core sealing element, and a lower cover. The housing has an opening end, an air outlet channel is provided on the housing. The lower cover covers the opening end of the housing to form a cavity, an air inlet hole is provided on the lower cover. The vaporization core sealing element is sleeved on the porous body, the vaporization core sealing element at least covers a part of an outer peripheral surface of the porous body and an edge of the liquid absorbing end, the vaporization core sealing element abuts against an inner wall of the housing. The electronic cigarette vaporization core is arranged in the cavity, a space between a vaporization end of the porous body and the lower cover forms a vaporization chamber, and the vaporization chamber is in communication with the air outlet channel and the air inlet hole respectively.

According to an embodiment of the present disclosure, the electronic cigarette includes the electronic cigarette vaporization core of the present disclosure, a housing, a liquid storage cavity provided in the housing, a vaporization core sealing element, and a lower cover. The housing has an opening end, an air outlet channel being provided on the housing. The lower cover covers the opening end of the housing, an air inlet hole is provided on the lower cover. The vaporization core sealing element is sleeved on the porous body, and the vaporization core sealing element at least covers a part of an outer peripheral surface of the porous body and an edge of the liquid absorbing end.

The electronic cigarette further includes an upper support and an upper support sealing element. The upper support is in fit connection with the lower cover to form a cavity, and the electronic cigarette vaporization core is located in the cavity. An e-liquid guiding hole is provided on the upper support, and the liquid absorbing end of the porous body is in communication with an e-liquid storage tank through the e-liquid guiding hole. The upper support sealing element is sleeved on an outer periphery of the upper support, an outer edge of the upper support sealing element abuts against an inner wall of the housing to enclose to form the e-liquid storage tank. A first communication hole configured to connect the e-liquid storage tank and the e-liquid guiding hole is provided on the upper support sealing element, and a second communication hole configured to connect the air outlet channel and the vaporization chamber is provided on the upper support sealing element.

According to an embodiment of the present disclosure, the electronic cigarette includes the electronic cigarette vaporization core of the present disclosure, a housing, a liquid storage cavity provided in the housing, a vaporization core sealing element, and a lower cover. The housing has an opening end, an air outlet channel is provided on the housing. The lower cover covers the opening end of the housing, an air inlet hole is provided on the lower cover. The vaporization core sealing element is sleeved on an outer periphery of the electronic cigarette vaporization core.

The electronic cigarette further includes an upper support, an upper support sealing element, and a lower support. The upper support and the lower support are engaged to form an accommodating cavity, the electronic cigarette vaporization core is arranged in the accommodating cavity. An e-liquid guiding hole is provided on the upper support, and the liquid absorbing end of the porous body is in communication with an e-liquid storage tank through the e-liquid guiding hole. A vaporization chamber is formed between the vaporization surface and the lower support. An air vent in communication with the air inlet hole is provided on the lower support. The upper support sealing element is sleeved on an outer periphery of the upper support, an outer edge of the upper support sealing element abuts against an inner wall of the housing to enclose to form the e-liquid storage tank. A first communication hole configured to connect the e-liquid storage tank and the c-liquid guiding hole is provided on the upper support sealing element, and a second communication hole configured to connect the air outlet channel and an air outlet hole is provided on the upper support sealing element.

The electronic cigarette further includes a lower cover sealing element. The lower cover sealing element is arranged around an outer periphery of the lower cover, and an outer edge of the lower cover sealing element abuts against the inner wall of the housing.

According to the embodiment of the present disclosure, a conductive nail penetrates the lower cover, and the conductive nail is electrically connected to the heating body.

A technical effect of the embodiments of the present disclosure is as follows.

According to the electronic cigarette vaporization core provided in the embodiment of the present disclosure, in the electronic cigarette vaporization core, the bump is arranged on the vaporization end of the porous body, the bump includes the end surface facing away from the porous body and the side surface located on an outer periphery of the bump, a distance between at least a part of the heating body and an edge of the end surface is less than a predetermined value, so that both at least a part of the end surface and at least a part of the side surface form vaporization surfaces, to avoid setting an excessively large vaporization surface area on the end surface of the bump, so that when the vaporization surface formed on the bump is fully used, on the basis of improving a heating speed of the heating body, utilization efficiency of the vaporization surface can be ensured, and heating efficiency of the heating body and an amount of vaporization of the electronic cigarette vaporization core are improved.

Other features and advantages of the present disclosure will become apparent from the following detailed description of exemplary embodiments of the present disclosure with reference to the drawings.

### BRIEF DESCRIPTION OF THE DRAWINGS

Accompanying drawings are incorporated into and constitute a part of this specification, show embodiments that conform to this application, and are used together with this specification to describe the principle of the present disclosure.

FIG. 1 is a top view of a first electronic cigarette vaporization core according to an embodiment of the present disclosure;

FIG. 2 is a three-dimensional view of a first electronic cigarette vaporization core according to an embodiment of the present disclosure;

FIG. 3 is a top view of a second electronic cigarette vaporization core according to an embodiment of the present disclosure;

FIG. 4 is a three-dimensional view of a second electronic cigarette vaporization core according to an embodiment of the present disclosure;

FIG. 5 is a top view of a fourth electronic cigarette vaporization core according to an embodiment of the present disclosure;

FIG. 6 is a top view of a fifth electronic cigarette vaporization core according to an embodiment of the present disclosure;

FIG. 7 is a top view of a sixth electronic cigarette vaporization core according to an embodiment of the present disclosure;

FIG. 8 is a three-dimensional view of a sixth electronic cigarette vaporization core according to an embodiment of the present disclosure;

FIG. 9 is a top view of a seventh electronic cigarette vaporization core according to an embodiment of the present disclosure;

FIG. 10 is a three-dimensional view of a seventh electronic cigarette vaporization core according to an embodiment of the present disclosure;

FIG. 11 is an exploded view of an electronic cigarette structure according to an embodiment of the present disclosure; and

FIG. 12 is a cross-sectional view of an electronic cigarette structure according to an embodiment of the present disclosure.

In the drawings:
1—porous body; 2—bump; 3—heating body; 4—wiring pad;
100—electronic cigarette vaporization core; 101—housing; 1011—air outlet channel; 102—e-liquid storage tank; 103—upper support; 1031—air outlet hole; 1032—e-liquid guiding hole; 104—lower support; 105—lower cover; 1051—air inlet hole; 106—vaporization chamber; 107—upper support sealing element; 1071—first communication hole; 1072—second communication hole; 108—vaporization core sealing element; 109—lower cover sealing element; and 1010—liquid absorbing element.

### DETAILED DESCRIPTION

Various exemplary embodiments of the present disclosure are now described in detail with reference to the accompanying drawings. It should be noted that, unless otherwise specified, opposite arrangement, numerical expressions, and numerical values of components and steps described in the embodiments do not limit the scope of the present disclosure.

The following descriptions of at least one exemplary embodiment are merely illustrative, and in no way constitute any limitation on the present disclosure and application or use of the present disclosure.

Technologies, methods, and devices known to those of ordinary skill in related arts may not be discussed in detail, but where appropriate, the techniques, the methods. and the devices should be considered as a part of the specification.

In all examples shown and discussed herein, any specific value should be construed as merely exemplary and not as limitations. Therefore, other examples of exemplary embodiments may have different values.

It should be noted that: similar reference signs or letters in the accompanying drawings indicate similar items. Therefore, once an item is defined in one accompanying drawing, the item does not need to be further discussed in the subsequent accompanying drawings.

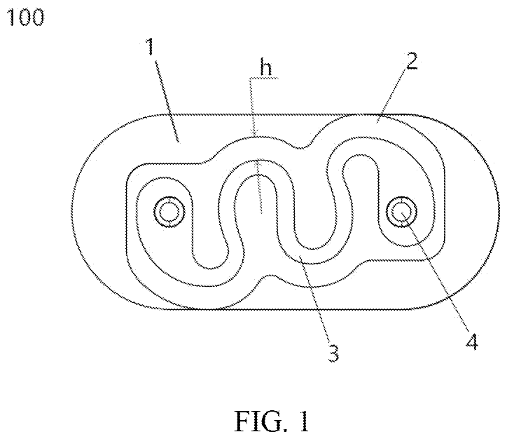

Referring to FIG. 1 to FIG. 6, an embodiment of the present disclosure provides an electronic cigarette vaporization core 100, which is used in an electronic cigarette. The electronic cigarette vaporization core 100 includes:
a porous body 1 and a heating body 3. The porous body 1 includes a liquid absorbing end and a vaporization end, a bump 2 is arranged on the vaporization end, and the bump 2 includes an end surface facing away from the porous body 1 and a side surface located on an outer periphery of the bump, where the side surface is a peripheral side surface adjacent to the end surface.

E-liquid inside the electronic cigarette penetrates into the vaporization end through the liquid absorbing end. The heating body 3 is arranged on the end surface, that is, the heating body 3 is arranged on one side of the bump 2 facing away from the porous body 1, and a distance between at least a part of the heating body 3 and an edge of the end surface is less than a predetermined value, so that both at least a part of the end surface and at least a part of the side surface form vaporization surfaces. Therefore, the end surface and the side surface of the bump 2 can be fully used to avoid setting an excessively large vaporization surface area on the end surface of the bump 2. so that when the vaporization surface formed on the bump 2 is fully used. on the basis of improving a heating speed of the heating body 3, an effective vaporization area of the vaporization surface can be ensured, and heating efficiency of the heating body and an amount of vaporization of the electronic cigarette vaporization core are improved.

In a specific implementation, the heating body 3 is bent in a circumferential direction of the bump 2 to form at least one raised section and/or at least one recessed section. At least one section of edge of the end surface matches a contour of the heating body 3, for example, the at least one section of edge of the end surface and a contour edge of the heating body 3 are arranged at an equal interval. When generating heat, the heating body 3 may vaporize e-liquid on the vaporization surface, to provide a user with vapor that can be inhaled.

The arrangement of the bump 2 can avoid setting the excessively large vaporization surface area. When the vaporization surface formed on the bump 2 is fully used, full utilization of the vaporization surface can be ensured through heating of the heating body, and utilization efficiency of the vaporization surface is improved. In addition, the heating body 3 is bent in the circumferential direction of the bump 2 to form at least one raised section and/or at least one recessed section, the raised section may heat and vaporize an edge and even the side surface of the bump 2, and the recessed section may heat and vaporize the middle of a surface on one side of the bump 2 facing away from the porous body 1. When the at least one section of edge of the end surface of the bump 2 matches the contour of the heating body 3, the heating body 3 may heat a surface and a side of the bump 2 uniformly when generating heat, to ensure the effective vaporization area of the vaporization surface and improve the heating efficiency of the heating body 3.

According to the electronic cigarette vaporization core 100 provided in this embodiment of the present disclosure, the bump 2 is arranged on the vaporization end of the porous body 1, and the heating body 3 is arranged on one side of the bump 2 facing away from the porous body 1, so that the vaporization surface is formed on the bump 2. The heating body 3 is bent to form the at least one raised section and/or the at least one recessed section. The at least one section of edge of the end surface matches the contour of the heating body 3. The arrangement of the bump 2 can avoid setting the excessively large vaporization surface area. When the vaporization surface formed on the bump 2 is fully used, full utilization of the vaporization surface can be ensured through heating of the heating body 3, and on the basis of improving the heating speed of the heating body 3 the utilization efficiency of the vaporization surface can be ensured. When the at least one section of edge of the end surface matches the contour of the heating body 3, the heating body 3 may heat the middle and the side of the bump 2 uniformly when generating heat, to ensure the effective vaporization area of the vaporization surface, improve the heating efficiency of the heating body 3 and the amount of vaporization of the electronic cigarette vaporization core 100, and ensure a vaporization effect of the electronic cigarette vaporization core 100.

In addition, a structure design of the electronic cigarette vaporization core 100 can also avoid an excessively high vaporization temperature of the heating body 3, to reduce harmful substances in an aerosol after e-liquid is vaporized, which is beneficial to health of an inhaler and enhances sense of trust of the inhaler for the electronic cigarette.

Optionally, a contour of the edge of the end surface forms a raised edge adapted to the raised section at a position corresponding to the raised section; and/or

the contour of the edge of the end surface forms a recessed edge adapted to the recessed section at a position corresponding to the recessed section.

Specifically, when the at least one section of edge of the end surface of the bump 2 matches the contour of the heating body 3, the heating body 3 may heat the surface and the side of the bump 2 uniformly when generating heat, to improve the heating efficiency of the heating body 3. That the end surface of the bump 2 matches the contour of the heating body 3 may be specifically that the contour of the edge of the end surface forms the raised edge adapted to the raised section at the position corresponding to the raised section, so that the raised edge of the end surface and the raised section are arranged at an equal interval; or the contour of the edge of the end surface forms the recessed edge adapted to the recessed section at the position corresponding to the recessed section, so that the recessed edge of the end surface and the recessed section are arranged at an equal interval.

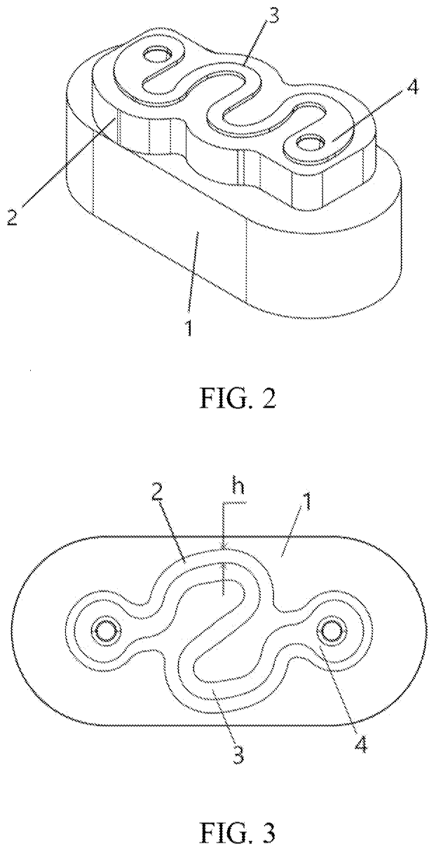

Optionally, referring to FIG. 1 and FIG. 2, the heating body 3 is arranged on the end surface in a shape of square wave.

Specifically, referring to FIG. 1, the heating body 3 in the shape of square wave may include a first bent section and a second bent section. A bending direction of the first bent section is opposite to a bending direction of the second bent section. Two ends of the heating body 3 are respectively a first connecting section and a second connecting section. The heating body 3 further includes a first heating section, a second heating section, and a third heating section. The first heating section is connected between the first connecting section and the first bent section, the second heating section are respectively connected to the first bent section and the second bent section, and the third heating section is connected between the second bent section and the second connecting section. Each of the first bent section and the second bent section may form a raised section, and each of the first heating section, the second heating section, and the third heating section may form a recessed section. The first connecting section and the second connecting section respectively extend to two ends of a first vaporization region, and the first heating section, the second heating section, the third heating section, the first bent section, and the second bent section may provide main heat sources for the heating body 3, to uniformly heat the vaporization surface.

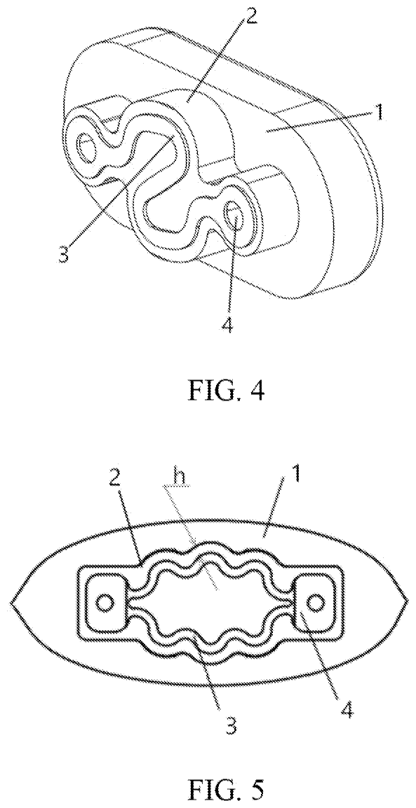

Optionally, referring to FIG. 3 and FIG. 4, the heating body 3 is arranged on the end surface in a zigzag shape.

Specifically, referring to FIG. 3, the heating body 3 in the zigzag shape may include a first bent section and a second bent section. A bending direction of the first bent section is opposite to a bending direction of the second bent section, and two ends of the heating body 3 are respectively a first connecting section and a second connecting section. The heating body 3 further includes a first heating section. The first heating section is connected between the first bent section and the second bent section. Each of the first bent section and the second bent section forms a raised section, and the first heating section forms a recessed section. The first connecting section and the second connecting section respectively extend to two ends of a first vaporization region, and the first heating section, the first bent section, and the second bent section may provide main heat sources for the heating body 3, to uniformly heat the vaporization surface.

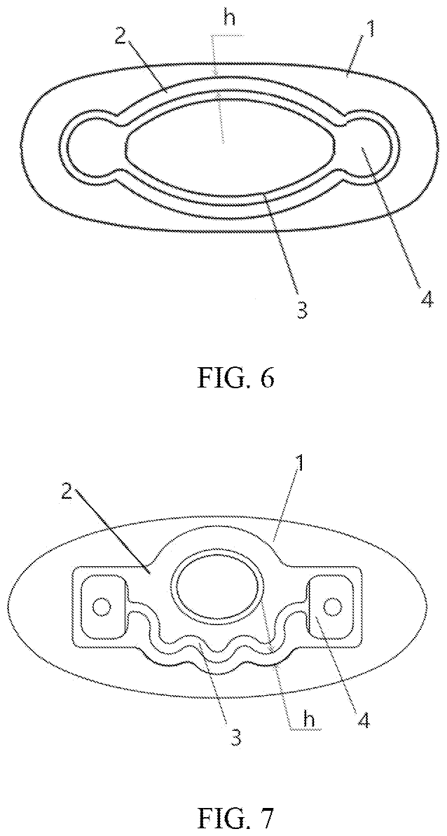

Optionally, the heating body 3 is arranged on the end surface in an S shape. That is, the heating body 3 is a structure symmetrical to the heating body 3 in the zigzag shape. and uniform heating of the vaporization surface can also be ensured. In addition, referring to FIG. 5, the heating body 3 may include an upper section and a lower section that are symmetrical, and each section may be bent to form a plurality of raised sections and a plurality of recessed sections. Alternatively, referring to FIG. 6, the heating body 3 may include an upper section and a lower section that are symmetrical, and each section may be bent to form a raised section.

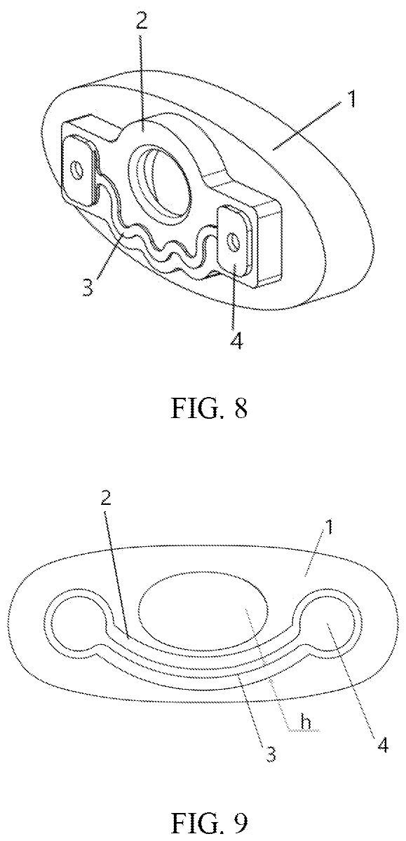

Optionally, referring to FIG. 7 and FIG. 8, the heating body 3 is arranged on the end surface in a wave shape.

Specifically, when the heating body 3 is in the wave shape, the heating body 3 may be bent to form a plurality of raised sections and a plurality of recessed sections. A contour of one side of the heating body 3 in the wave shape may match the edge of the end surface of the bump 2, for example, an edge of one side of the heating body 3 and the edge of the end surface of the bump 2 are arranged at an equal interval, which is shown in FIG. 7. Alternatively, both edges of two sides of the heating body 3 in the wave shape may match the edge of the end surface of the bump 2, for example, the edges of the two sides of the heating body 3 and the edge of the end surface of the bump 2 are arranged at an equal interval, so that the end surface of the bump 2 also forms an end surface in a wave shape.

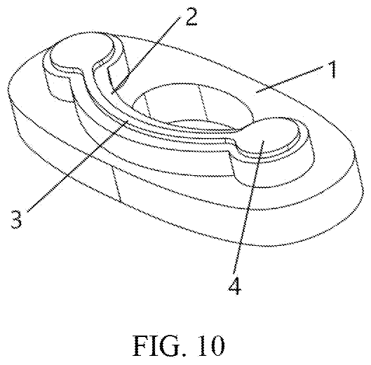

Optionally, referring to FIG. 9 and FIG. 10, the heating body 3 is arranged on the end surface in an arc shape.

Specifically, when the heating body 3 is in the arc shape, the heating body 3 may be bent to form a raised section. A contour of one side of the heating body 3 in the arc shape may match the edge of the end surface of the bump 2, for example, an edge of an outer side of the heating body 3 and the edge of the end surface of the bump 2 are arranged at an equal interval. Alternatively, both edges of two sides of the heating body 3 in the arc shape may match the edge of the end surface of the bump 2, for example, the edges of the two sides of the heating body 3 and the edge of the end surface of the bump 2 are arranged at an equal interval, so that the end surface of the bump 2 also forms an end surface in an arc shape, which is shown in FIG. 9.

Optionally, a distance between an overall contour of the heating body 3 and the edge of the end surface ranges from 0.05 mm to 4.0 mm.

Specifically, the at least one section of edge of the end surface matches the contour of the heating body 3, for example, the at least one section of edge of the end surface of the bump 2 and an edge of the contour of the heating body 3 are arranged at an equal interval, so that uniformity of heating and vaporization of this section of edge of the end surface of the bump 2 can be ensured. In addition, to further improve the uniformity of heating of the end surface and even the side surface of the bump 2, the overall contour of the heating body 3 may match the edge of the end surface, so that the distance between the overall contour of the heating body 3 and the edge of the end surface is controlled within a range of 0.05 mm to 4.0 mm.

Optionally, referring to FIG. 1, FIG. 3, and FIG. 5, a distance h between the raised section and the edge of the end surface of the bump 2 ranges from 0.1 mm to 2.0 mm, and preferably, from 0.5 mm to 1.0 mm; and/or

a distance between the recessed section and the edge of the end surface ranges from 0.1 mm to 4.0 mm, and preferably, from 0.5 mm to 2.0 mm.

Specifically, when the contour of the heating body 3 matches the edge of the end surface of the bump 2, the raised section and/or the recessed section and the edge of the end surface of the bump 2 may be arranged at an equal interval. When the distance h between the raised section and/or the recessed section and the edge of the end surface of the bump 2 is controlled within a range of 0.1 mm to 2.0 mm, on the basis of ensuring the effective vaporization area of the vaporization surface, the raised section can heat and vaporize the edge of the end surface of the bump 2 and even the side surface of the bump 2, to improve the vaporization efficiency of the heating body 3.

Optionally, the bump 2 and the porous body 1 are integrally formed.

Specifically, a material of the bump 2 may be the same as a material of the porous body 1, for example, both the bump and the porous body adopt a porous ceramic material. The bump 2 and the porous body 1 may be integrally formed in a mold and then shapes are fixed through a process such as baking. In addition, the bump 2 may alternatively be obtained by cutting after a regular vaporization core is formed. A forming manner of the bump 2 is not limited in this embodiment of the present disclosure.

Optionally, referring to FIG. 1 to FIG. 6, the electronic cigarette vaporization core 100 further includes a wiring pad 4. The wiring pad 4 is connected to two ends of the heating body 3.

A ratio of an area of the wiring pad 4 to an area of the end surface is 0.02 to 0.25, and preferably, 0.15 to 0.2.

In some implementations, referring to FIG. 1 to FIG. 6, the wiring pad 4 is arranged on the end surface, an electrode is arranged on the wiring pad 4, and the electrode is configured to be electrically connected to an external power supply. An end portion of the wiring pad 4 may be arranged in an are shape, to allow the ratio of the area of the wiring pad 4 to the area of the end surface to be controlled within a range of 0.02 to 0.25, so that the area of the wiring pad 4 is prevented from excessively occupying the area of the end surface of the bump 2, heat absorption of the heating body 3 by the wiring pad 4 is reduced, and vaporization efficiency of the heating body 3 is improved.

Specifically, the electrode on the wiring pad 4 may include a positive electrode and a negative electrode. When the heating body 3 is used in the electronic cigarette, a power supply in the electronic cigarette applies a voltage to the positive electrode and the negative electrode, to energize the heating body 3. When being energized, the heating body 3 may convert electric energy to heat energy, and when generating heat, the heating body 3 may vaporize e-liquid on the vaporization end of the electronic cigarette vaporization core 100, to ensure a vaporization effect of the electronic cigarette.

Optionally, a height of the bump 2 ranges from 0.1 mm to 5 mm, and preferably, from 0.5 mm to 1.5 mm.

Specifically, the arrangement of the bump 2 can avoid setting the excessively large vaporization surface area. When the vaporization surface formed on the bump 2 is fully used, full utilization of the vaporization surface can be ensured through heating of the heating body 3, and on the basis of improving the heating speed of the heating body 3, the utilization efficiency of the vaporization surface is ensured. When the height of the bump 2 is excessively low, it is inconvenient to form a significant end surface on the bump 2, which brings an obstacle to the arrangement of the heating body 3. When the height of the bump 2 is excessively high, the bump occupies an excessively large area of the electronic cigarette vaporization core 100 and increases a penetration path of e-liquid of the electronic cigarette, which reduces the vaporization efficiency of the electronic cigarette vaporization core 100.

The present disclosure further provides an electronic cigarette. The electronic cigarette includes the electronic cigarette vaporization core 100.

Specifically, in the electronic cigarette vaporization core 100 of the electronic cigarette, the bump 2 is arranged on the vaporization end of the porous body 1, the heating body 3 is arranged on one side of the bump 2 facing away from the porous body 1, so that a vaporization surface is formed on the bump 2, the heating body 3 is bent to form at least one raised section and/or at least one recessed section, and a contour of the heating body 3 matches an edge of the bump 2. The arrangement of the bump 2 can avoid setting an excessively large vaporization surface area. When the vaporization surface formed on the bump 2 is fully used, full utilization of the vaporization surface can be ensured through heating of the heating body, and on the basis of improving a heating speed of the heating body 3, utilization efficiency of the vaporization surface is ensured. When the contour of the heating body 3 matches the edge of the bump 2, the heating body 3 may heat a middle and a side of the bump 2 uniformly when generating heat, to ensure an effective vaporization area of the vaporization surface, improve heating efficiency of the heating body 3 and an amount of vaporization of the electronic cigarette vaporization core 100, and ensure a vaporization effect of the electronic cigarette.

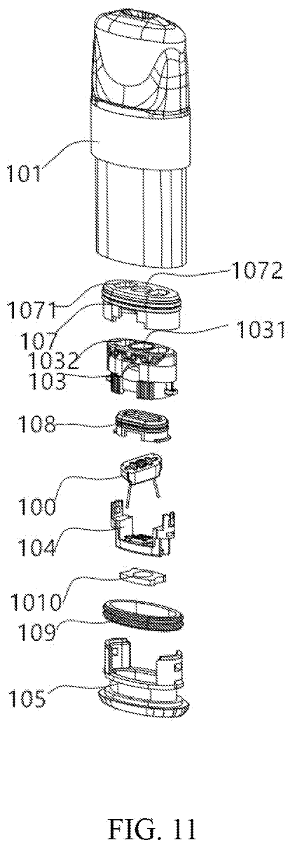

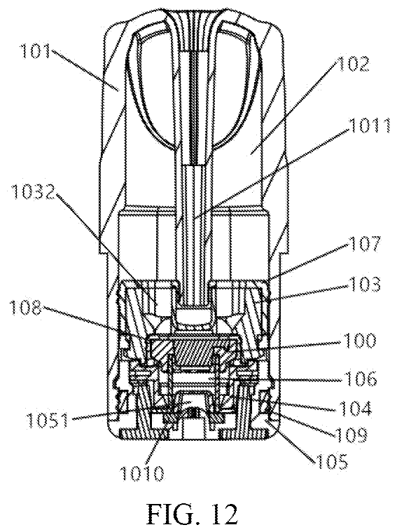

Optionally, referring to FIG. 11 and FIG. 12, the electronic cigarette further includes a housing 101, a liquid storage cavity 102 provided in the housing 101, and a vaporization core sealing element 108. The vaporization core sealing element 108 is sleeved on the porous body 1, and the vaporization core sealing element 108 covers at least a part of an outer peripheral surface of the porous body 1 and an edge of the liquid absorbing end.

Specifically, when being sleeved on the porous body 1, that is, when being sleeved on an outer periphery of the vaporization core 100, the vaporization core sealing element 108 may effectively seal e-liquid on the liquid absorbing end, to avoid leakage of the e-liquid.

According to an embodiment of the present disclosure, the electronic cigarette further includes:
an upper support 103, a lower support 104, and a lower cover 105. The lower cover 105 covers an opening end of the housing 101. An air inlet hole 1051 is provided on the lower cover 105.

The upper support 103 and the lower support 104 are engaged to form an accommodating cavity, and the electronic cigarette vaporization core 100 is arranged in the accommodating cavity.

An e-liquid guiding hole 1032 is provided on the upper support 103, and the liquid absorbing end of the porous body 1 is in communication with an e-liquid storage tank 102 through the e-liquid guiding hole 1032. A vaporization chamber 106 is formed between the vaporization surface and the lower support 104, and an air vent in communication with the air inlet hole 1051 is provided on the lower support 104.

Specifically, when the electronic cigarette vaporization assembly works, e-liquid flowing out from the e-liquid storage tank 102 is guided to the liquid absorbing end of the porous body 1 through the e-liquid guiding hole 1032, then is absorbed through capillary action of the porous body 1 to the heating body 3 on the vaporization end of the porous body 1, and then is vaporized through heating of the heating body 3. In this case, under an inhalation action of the air outlet channel 1011, a user drives air in the air inlet hole 1051 to enter the vaporization chamber 106, and the air carrying an aerosol in the vaporization chamber 106 is guided to the air outlet channel 1011. Because the e-liquid is continuously absorbed by the porous body 1 and supplemented to the heating body 3, a negative pressure is formed in the e-liquid storage tank 102, and under an action of the negative pressure, external air may pass through the vaporization chamber 106 and the electronic cigarette vaporization core 100 and then enter the e-liquid guiding hole 1032 and the e-liquid storage tank 102, to form a balance air pressure, thereby ensuring that the e-liquid can be smoothly guided to the porous body 1.

Optionally, referring to FIG. 11 and FIG. 12, the electronic cigarette further includes an upper support sealing element 107 and a lower cover sealing element 109.

The upper support sealing element 107 is sleeved on an outer periphery of the upper support 103, an outer edge of the upper support sealing element 107 abuts against an inner wall of the housing 101 to enclose to form the e-liquid storage tank 102, a first communication hole 1071 configured to connect the e-liquid storage tank 102 and the e-liquid guiding hole 1032 is provided on the upper support sealing element 107, and a second communication hole 1072 configured to connect the air outlet channel 1011 and an air outlet hole 1031 is provided on the upper support sealing element 107.

The vaporization core sealing element 108 is sleeved on an outer periphery of the electronic cigarette vaporization core 100. The lower cover sealing element 109 is arranged around an outer periphery of the lower cover 105, and an outer edge of the lower cover sealing element 109 abuts against the inner wall of the housing 101.

Specifically, the upper support sealing element 107, the vaporization core sealing element 108, and the lower cover sealing element 109 are configured to provide necessary sealing inside the electronic cigarette, to avoid unnecessary conduction of the e-liquid storage tank 102 and connection gaps of various elements, thereby effectively avoiding occurrence of e-liquid leakage. In addition, the electronic cigarette further includes a liquid absorbing element 1010. The liquid absorbing element 1010 is arranged around an outer periphery of the air inlet hole 1051, and the liquid absorbing element 1010 is configured to absorb condensed liquid flowing out from the air inlet hole 1051.

According to an embodiment of the present disclosure, the electronic cigarette may not include the lower support, that is, the upper support 103 is in direct fit connection with the lower cover 105 to form an accommodating cavity. The electronic cigarette vaporization core 100 is located in the accommodating cavity, and the upper support 103 may be in fit connection with the lower cover 105 in an engagement manner. Referring to FIG. 11 and FIG. 12, a detailed description is provided. The electronic cigarette includes the electronic cigarette vaporization core 100, a housing 101, a liquid storage cavity 102 provided in the housing 101, a vaporization core sealing element 108, and a lower cover 105. The housing 101 has an opening end, an air outlet channel 1011 is provided on the housing 101, the lower cover 105 covers the opening end of the housing 101, an air inlet hole 1051 is provided on the lower cover 105, the vaporization core sealing element 108 is sleeved on the porous body 1, and the vaporization core sealing element 108 covers at least a part of an outer peripheral surface of the porous body 1 and an edge of the liquid absorbing end.

In this embodiment, the electronic cigarette further includes an upper support 103 and an upper support sealing element 107. The upper support 103 is in fit connection with the lower cover 105 to form a cavity, and the electronic cigarette vaporization core 100 is located in the cavity. An e-liquid guiding hole 1032 is provided on the upper support 103, and the liquid absorbing end of the porous body 1 is in communication with an e-liquid storage tank 102 through the e-liquid guiding hole 1032. The upper support sealing element 107 is sleeved on an outer periphery of the upper support 103, an outer edge of the upper support sealing element 107 abuts against an inner wall of the housing 101 to enclose to form the e-liquid storage tank 102, a first communication hole 1071 configured to connect the e-liquid storage tank 102 and the e-liquid guiding hole 1032 is provided on the upper support sealing element 107, and a second communication hole 1072 configured to connect the air outlet channel 1011 and the vaporization chamber 106 is provided on the upper support sealing element 107. In this embodiment, the electronic cigarette may not include the lower support 104, and the upper support 103 is engaged with the lower cover 105 to fix the electronic cigarette vaporization core 100.

Optionally, the electronic cigarette includes:
a housing;
a liquid storage tank, located in the housing;
a lower base, being in fit connection with the housing to form an accommodating cavity, where an air inlet channel is provided on the lower base; and
a vaporization core sealing member, located in the accommodating cavity, where the vaporization core sealing member is sleeved on the porous body 1 of the electronic cigarette vaporization core 100, and the vaporization core sealing member is in interference fit with the housing and the porous body 1.

Specifically, the electronic cigarette vaporization assembly has a simple structure, and a component in the housing occupies less space, so that a space volume inside the electronic cigarette that can be used to form a vaporization cavity is increased. Compared with a related art, the electronic cigarette vaporization assembly in the solution adopts only a form of matching between the housing and the lower base to limit the structures such as the vaporization core, thereby simplifying the internal structure of the electronic cigarette vaporization assembly and leaving more space for the vaporization core and the vaporization cavity. In such an electronic cigarette vaporization assembly, the volume of the vaporization cavity can be larger than that in the related art, and effective use time of the electronic cigarette can be improved. That is, the electronic cigarette in the present disclosure may further not include the upper support 103 and the lower support 104. Because the vaporization core sealing element 108 is sleeved on the porous body 1 and is in interference fit with both the inner wall of the housing 101 and the porous body, that is, the electronic cigarette vaporization core 100 is fixed through interference fit between the vaporization core sealing element 108 and the inner wall of the housing 101. Referring to FIG. 11 and FIG. 12, a detailed description of this embodiment is provided. The electronic cigarette includes the electronic cigarette vaporization core 100, a housing 101, a liquid storage cavity 102 provided in the housing 101, a vaporization core sealing element 108, and a lower cover 105. The housing 101 has an opening end, an air outlet channel 1011 is provided on the housing 101, the lower cover 105 covers the opening end of the housing 101 to form a cavity, an air inlet hole 1051 is provided on the lower cover 105, the vaporization core sealing element 108 is sleeved on the porous body 1, the vaporization core sealing element 108 covers at least a part of an outer peripheral surface of the porous body 1 and an edge of the liquid absorbing end, the vaporization core sealing element 108 abuts against an inner wall of the housing, the electronic cigarette vaporization core 100 is arranged in the cavity, a space between a vaporization end of the porous body 1 and the lower cover 105 forms a vaporization chamber 106, and the vaporization chamber 106 is in communication with the air outlet channel 1011 and the air inlet hole 1051 respectively.

According to the electronic cigarette of the present disclosure, a conductive nail penetrates the lower cover 105, and the conductive nail is electrically connected to the heating body 3.

Although some specific embodiments of the present disclosure have been described in detail by way of examples, a person skilled in the art should understand that the foregoing examples are only for description and are not intended to limit the scope of the present disclosure. A person skilled in the art should appreciate that modifications may be made to the foregoing embodiments without departing from the scope and spirit of the present disclosure. The scope of the present disclosure is limited only by the appended claims.

What is claimed is:

1. An electronic cigarette vaporization core (100), comprising:
a porous body (1), the porous body (1) comprising a liquid absorbing end and a vaporization end, a bump (2) being arranged on the vaporization end, and the bump (2) comprising an end surface facing away from the porous body (1) and a side surface located on an outer periphery of the bump (2); and
a heating body (3), the heating body (3) being arranged on the end surface, and a distance between at least a part of the heating body and an edge of the end surface being less than a predetermined value, so that both at least a part of the end surface and at least a part of the side surface form vaporization surfaces.

2. The electronic cigarette vaporization core (100) according to claim 1, wherein the heating body (3) is bent in a circumferential direction of the bump (2) to form at least one raised section, or the heating body (3) is bent in a circumferential direction of the bump (2) to form at least one recessed section, or the heating body (3) is bent in a circumferential direction of the bump (2) to form at least one raised section and at least one recessed section.

3. The electronic cigarette vaporization core (100) according to claim 2, wherein
a contour of the edge of the end surface forms a raised edge adapted to the raised section at a position corresponding to the raised section.

4. The electronic cigarette vaporization core (100) according to claim 2, wherein the contour of the edge of the end surface forms a recessed edge adapted to the recessed section at a position corresponding to the recessed section.

5. The electronic cigarette vaporization core (100) according to claim 3, wherein the contour of the edge of the end surface forms a recessed edge adapted to the recessed section at a position corresponding to the recessed section.

6. The electronic cigarette vaporization core (100) according to claim 1, wherein the heating body (3) is arranged on the end surface in a shape of square wave.

7. The electronic cigarette vaporization core (100) according to claim 1, wherein the heating body (3) is arranged on the end surface in an S shape.

8. The electronic cigarette vaporization core (100) according to claim 1, wherein the heating body (3) is arranged on the end surface in a wave shape.

9. The electronic cigarette vaporization core (100) according to claim 1, wherein the heating body (3) is arranged on the end surface in an arc shape.

10. The electronic cigarette vaporization core (100) according to claim 2, wherein a distance between an overall contour of the heating body (3) and the edge of the end surface ranges from 0.05 mm to 4.0 mm.

11. The electronic cigarette vaporization core (100) according to claim 10, wherein a distance between the raised section and the edge of the end surface ranges from 0.1 mm to 2.0 mm.

12. The electronic cigarette vaporization core (100) according to claim 10, wherein a distance between the recessed section and the edge of the end surface ranges from 0.1 mm to 4.0 mm.

13. The electronic cigarette vaporization core (100) according to claim 1, further comprising a wiring pad (4), the wiring pad (4) being connected to two ends of the heating body (3); and
a ratio of an area of the wiring pad (4) to an area of the end surface being 0.02 to 0.25.

14. The electronic cigarette vaporization core (100) according to claim 1, wherein a height of the bump (2) ranges from 0.1 mm to 5 mm.

15. The electronic cigarette vaporization core (100) according to claim 1, wherein the bump (2) and the porous body (1) are integrally formed.

16. An electronic cigarette, comprising the electronic cigarette vaporization core (100) according to claim 1.

17. An electronic cigarette, comprising the electronic cigarette vaporization core (100) according to claim 1, a housing (101), a liquid storage cavity (102) provided in the housing (101), a vaporization core sealing element (108), and a lower cover (105), the housing (101) having an opening end, an air outlet channel (1011) being provided on the housing (101), the lower cover (105) covering the opening end of the housing (101) to form a cavity, an air inlet hole (1051) being provided on the lower cover (105), the vaporization core sealing element (108) being sleeved on the porous body (1), the vaporization core sealing element (108) at least covering a part of an outer peripheral surface of the porous body (1) and an edge of the liquid absorbing end, the vaporization core sealing element (108) abutting against an inner wall of the housing, the electronic cigarette vaporization core (100) being arranged in the cavity, a space between the vaporization end of the porous body (1) and the lower cover (105) forming a vaporization chamber (106), and the vaporization chamber (106) being in communication with the air outlet channel (1011) and the air inlet hole (1051), respectively.

18. An electronic cigarette, comprising the electronic cigarette vaporization core (100) according to claim 1, a housing (101), a liquid storage cavity (102) provided in the housing (101), a vaporization core sealing element (108), and a lower cover (105), the housing (101) having an opening end, an air outlet channel (1011) being provided on the housing (101), the lower cover (105) covering the opening end of the housing (101), an air inlet hole (1051) being provided on the lower cover (105), the vaporization core sealing element (108) being sleeved on the porous body (1), and the vaporization core sealing element (108) at least covering a part of an outer peripheral surface of the porous body (1) and an edge of the liquid absorbing end; and
further comprising an upper support (103) and an upper support sealing element (107), the upper support (103) being in fit connection with the lower cover (105) to form a cavity, and the electronic cigarette vaporization core (100) being located in the cavity; an e-liquid guiding hole (1032) being provided on the upper support (103), and the liquid absorbing end of the porous body (1) being in communication with an e-liquid storage tank (102) through the e-liquid guiding hole (1032); and the upper support sealing element (107) being sleeved on an outer periphery of the upper support (103), an outer edge of the upper support sealing element (107) abutting against an inner wall of the housing (101) to enclose to form the e-liquid storage tank (102), a first communication hole (1071) configured to connect the e-liquid storage tank (102) and the e-liquid guiding hole (1032) being provided on the upper support sealing element (107), and a second communication hole (1072) configured to connect the air outlet channel (1011) and the vaporization chamber (106) being provided on the upper support sealing element (107).

19. An electronic cigarette, comprising the electronic cigarette vaporization core (100) according to claim 1, a housing (101), a liquid storage cavity (102) provided in the housing (101), a vaporization core sealing element (108), and a lower cover (105), the housing (101) having an opening end, an air outlet channel (1011) being provided on the housing (101), the lower cover (105) covering the opening end of the housing (101), an air inlet hole (1051) being provided on the lower cover (105), and the vaporization core sealing element (108) being sleeved on an outer periphery of the electronic cigarette vaporization core (100);
further comprising an upper support (103), an upper support sealing element (107), and a lower support (104), the upper support (103) and the lower support (104) being engaged to form an accommodating cavity, the electronic cigarette vaporization core (100) being arranged in the accommodating cavity, an e-liquid guiding hole (1032) being provided on the upper support (103), and the liquid absorbing end of the porous body (1) being in communication with an e-liquid storage tank (102) through the c-liquid guiding hole (1032); and a vaporization chamber (106) being formed between the vaporization surface and the lower support (104), an air vent in communication with the air inlet hole (1051) being provided on the lower support (104), the upper support sealing element (107) being sleeved on an outer periphery of the upper support (103), an outer edge of the upper support sealing element (107) abutting against an inner wall of the housing (101) to enclose to form the e-liquid storage tank (102), a first communication hole (1071) configured to connect the e-liquid storage tank (102) and the e-liquid guiding hole (1032) being provided on the upper support sealing element (107), and a second communication hole (1072) configured to connect the air outlet channel (1011) and an air outlet hole (1031) being provided on the upper support sealing element (107); and
further comprising a lower cover sealing element (109), the lower cover sealing element (109) being arranged around an outer periphery of the lower cover (105), and an outer edge of the lower cover sealing element (109) abutting against the inner wall of the housing (101).

20. The electronic cigarette according to claim 17, wherein a conductive nail penetrates the lower cover (105), and the conductive nail being electrically connected to the heating body (3).
